(19) United States
(12) Patent Application Publication
(10) Pub. No.: US 2018/0101269 A1
(43) Pub. Date: Apr. 12, 2018

(54) TOUCH PANEL AND DISPLAY DEVICE INCLUDING THE SAME

(71) Applicant: LG ELECTRONICS INC., Seoul (KR)

(72) Inventors: Weonwoong LEE, Seoul (KR); Jeongseok LEE, Seoul (KR)

(73) Assignee: LG ELECTRONICS INC., Seoul (KR)

(21) Appl. No.: 15/568,380

(22) PCT Filed: Apr. 20, 2016
(86) PCT No.: PCT/KR2016/004097

§ 371 Date: Oct. 20, 2017

(30) Foreign Application Priority Data
Apr. 21, 2015 (KR) 10-2015-0056157

(51) Int. Cl. G06F 3/041; G02F 1/1333; G06F 3/044

(52) U.S. Cl. CPC G06F 3/0412; G06F 2203/04103; G06F 3/044; G02F 1/13338

(57) ABSTRACT

A touch panel according to an embodiment of the present invention comprises: a first conductive film including a first sensor electrode on one surface thereof; a second conductive film including a second sensor electrode insulated from the first sensor electrode; and a transparent adhesive layer positioned between the first conductive film and the second conductive film. The first sensor electrode is positioned on one surface of the first conductive film, which faces the transparent adhesive layer, and the second sensor electrode is positioned on one surface of the second conductive film, which faces the transparent adhesive layer. The other surface of the first conductive film, which is opposite to the one surface thereof, is positioned on the top surface to constitute an outer surface.

### TECHNICAL FIELD

The present invention relates to a touch panel and a display device including the same, and more particularly, to a touch panel having an improved structure and a display panel including the same.

### BACKGROUND ART

Recently, in order to provide user convenience, a touch panel is applied to various electronic devices, such as a display panel, etc. Such a touch panel may include at least one conductive film including electrodes for sensing touch, and a cover glass substrate positioned as a top layer on the front surface of the conductive film to constitute an outer surface of the touch panel.

If the touch panel includes the cover glass substrate, moisture resistance may be improved and external impact may be withstood. However, use of the cover glass substrate may raise manufacturing costs of the touch panel and increase the thickness and weight of the touch panel. Particularly, as consumer requirements are diversified according to development of display devices, if a touch panel applied to a display device not requiring high reliability and durability includes a cover glass substrate, inconvenience caused by the cover glass substrate may feel higher.

### DISCLOSURE

### Technical Problem

An object of the present invention devised to solve the problem lies on a touch panel which may reduce manufacturing costs and have light weight and small thickness, and a display panel including the same.

### Technical Solution

The object of the present invention can be achieved by providing a touch panel including a first conductive film including first sensor electrodes on one surface thereof, a second conductive film including second sensor electrodes insulated from the first sensor electrodes, and a transparent adhesive layer positioned between the first conductive film and the second conductive film, wherein the first sensor electrodes are positioned on one surface of the first conductive film facing the transparent adhesive layer, the second sensor electrodes are positioned on one surface of the second conductive film facing the transparent adhesive layer, and the other surface of the first conductive film opposite to the one surface thereof is positioned on a top surface of the touch panel to constitute an outer surface of the touch panel.

In another aspect of the present invention, provided herein is a display device including a display panel and a touch panel integrated with the display panel, wherein the touch panel includes a first conductive film including first sensor electrodes on one surface thereof, a second conductive film including second sensor electrodes insulated from the first sensor electrodes, and a transparent adhesive layer positioned between the first conductive film and the second conductive film, wherein the first sensor electrodes are positioned on one surface of the first conductive film facing the transparent adhesive layer, the second sensor electrodes are positioned on one surface of the second conductive film facing the transparent adhesive layer, and the other surface of the first conductive film opposite to the one surface thereof is positioned on a top surface of the touch panel.

### Advantageous Effects

A touch panel in accordance with one embodiment does not use a separate cover glass substrate and may thus have reduced thickness and weight and reduce manufacturing costs. Particularly, the touch panel is applied to a display device, which does not require high reliability and durability, and may thus reduce manufacturing costs and improve portability.

### DESCRIPTION OF DRAWINGS

FIG. 1 is a plan view illustrating a touch panel in accordance with one embodiment of the present invention.

FIG. 2 is a schematic cross-sectional view taken along line II-II of FIG. 1.

FIG. 3 is a cross-sectional view illustrating a touch panel in accordance with another embodiment of the present invention.

FIG. 4 is a cross-sectional view illustrating a display device in accordance with one embodiment of the present invention.

FIG. 5 is a cross-sectional view illustrating a display device in accordance with another embodiment of the present invention.

### BEST MODE

Hereinafter, embodiments of the present invention will be described in detail with reference to the accompanying drawings. While the invention will be described in conjunction with exemplary embodiments, it will be understood that the present description is not intended to limit the invention to the exemplary embodiments.

In the drawings, in order to clearly and briefly describe the invention, parts which are not related to the description will be omitted and, in the following description of the embodiments, the same or similar elements are denoted by the same reference numerals even though they are depicted in different drawings. In addition, in order to more clearly describe the invention, thicknesses, areas, etc. of elements in the drawings are enlarged or reduced and thus the thicknesses, areas, etc. of the elements are not limited to the drawings.

In the following description of the embodiments, it will be understood that, when a part “includes” another part, the part may further include other parts and does not exclude presence of the parts, unless stated otherwise. In addition, it will be understood that, when a part, such as a layer, a film, a region, or a plate, is “on” another part, the part may be located “directly on” the other part and other parts may be interposed between both parts. It will be understood that, when a part, such as a layer, a film, a region, or a plate, is “directly on” another part, it means that no part is interposed between both parts.

Further, terms “first”, “second”, etc. are used only to discriminate elements from each other and do not limit the invention.

Hereinafter, a touch panel and a display device including the same in accordance with one embodiment of the present invention will be described in detail with reference to the accompanying drawings. The touch panel will be first described and the display device including the same will then be described.

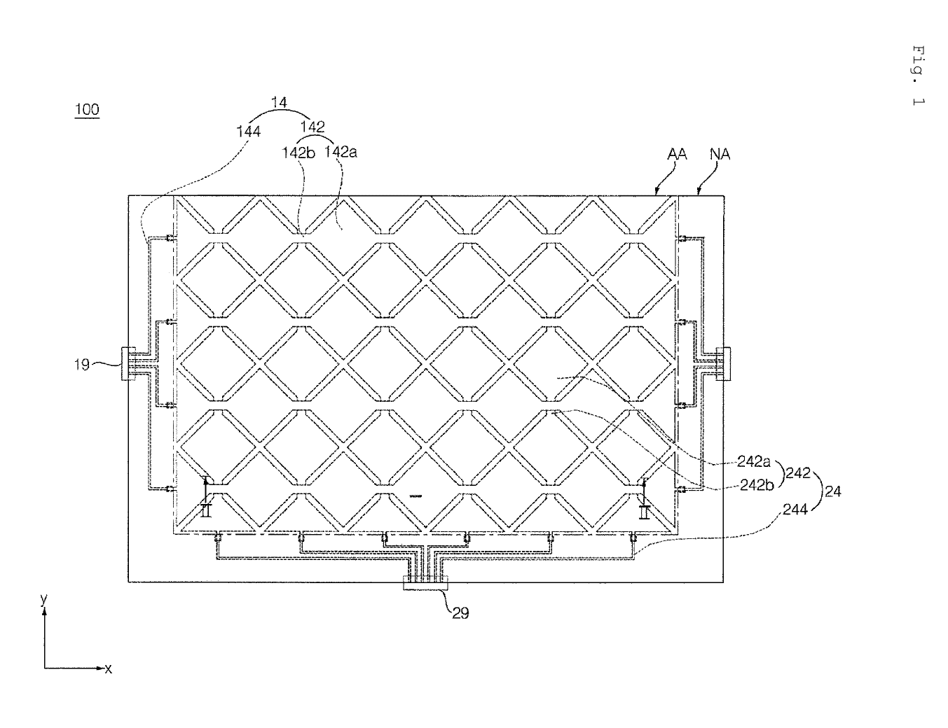

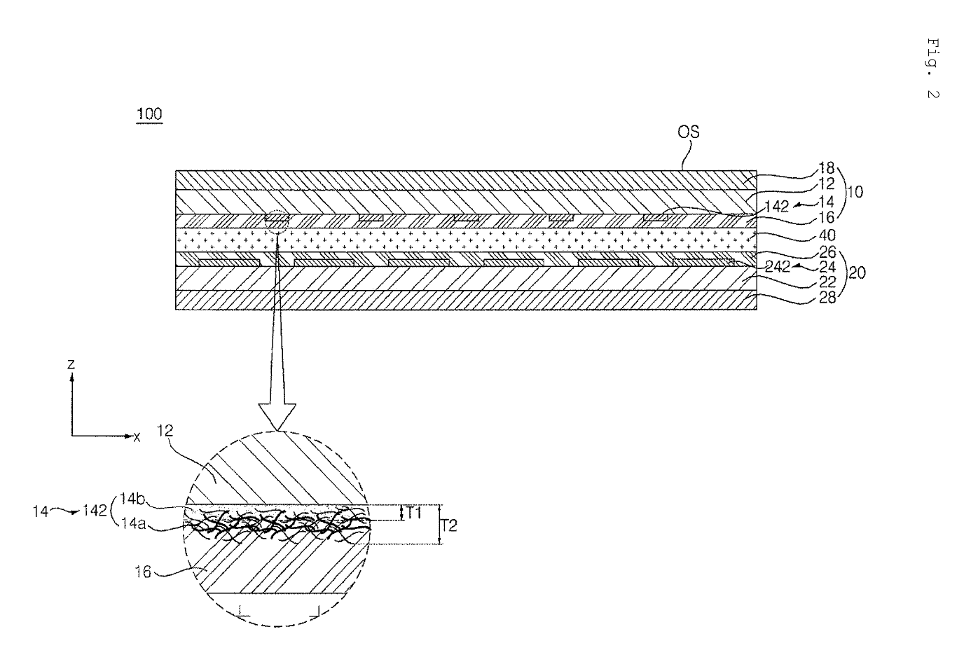

FIG. 1 is a plan view illustrating a touch panel in accordance with one embodiment of the present invention, and FIG. 2 is a schematic cross-sectional view taken along line II-II of FIG. 1. For the purpose of more clear and brief illustration, in FIG. 1, a transparent adhesive layer 40, first and second base members 12 and 22, first and second overcoating layers 16 and 26, etc. are omitted, and first and second electrodes 14 and 24 are illustrated.

With reference to FIGS. 1 and 2, a touch panel 100 in accordance with this embodiment may be defined as having an active area AA and non-active areas NA located at the outside of the active area AA. In the active area AA, sensor electrodes 142 and 242 of the first and second electrodes 14 and 24 are located and thus touch of an input unit, such as a user's hand or a stylus, is sensed. In the non-active areas NA, flexible printed circuit boards (FPCBs) 19 and 29 connected to the outside (an external circuit, for example, a touch control unit (not shown) controlling the touch panel 100 in a display panel), wiring electrodes 144 and 244 of the first and second electrodes 14 and 24 connected thereto, etc. are located so as to transmit information sensed from the active area AA. Further, in the non-active areas NA, a bezel (not shown), which physically fixes various layers, parts, etc. of the touch panel 100 and covers various elements located in the non-active areas NA, or a black printed layer (not shown) may be located. This embodiment exemplarily illustrates that the non-active areas NA are formed along the circumference of the active area AA so as to surround the active area AA. However, the present invention is not limited thereto and the non-active areas NA may be variously modified, i.e., the non-active areas NA may not be visible when viewed from the front or viewed from the top.

The touch panel 100 in accordance with this embodiment includes a first conductive film 10 including the first sensor electrodes 142 (additionally including the first wiring electrodes 144), a second conductive film 20 including the second sensor electrodes 242 insulated from the first sensor electrodes 142 (additionally including the second wiring electrodes 244), and a transparent adhesive layer 40 positioned between the first conductive film 10 and the second conductive film 20 and adhering first conductive film 10 and the second conductive film 20 to each other. Here, the first sensor electrodes 142 are located on one surface of the first conductive film 10 which faces the transparent adhesive layer 40, and the second sensor electrodes 242 are located on one surface of the second conductive film 20 which faces the transparent adhesive layer 40. Thereby, the first sensor electrodes 142 and the second sensor electrodes 242 are opposite each other with the transparent adhesive layer 40 interposed therebetween. The other surface (the upper surface in the drawings) of the first conductive film 10, which is opposite to the surface (the lower surface in the drawings) of the first conductive film 10 on which the first sensor electrodes 142 are located, is positioned as a top surface and thus constitutes an outer surface OS. This will be described in more detail below.

The first conductive film 10 may include a first base member 12, the first electrodes 14 formed on one surface of the first base member 12, a first overcoating layer 16 covering the first electrodes 14 at least in the active area AA, and a first hard coating layer 18 located on the other surface of the first base member 12 opposite to the first electrodes 14 and the first overcoating layer 16. Here, the first electrodes 14 may include the first sensor electrodes 142 located in the active area AA, and the first wiring electrodes 144 conductively connected to the first sensor electrodes 142 in the non-active areas NA.

The first base member 12 may be one of a film, a sheet, etc. formed of a material which is light transmissive and has insulating properties while maintaining mechanical strength of the first conductive film 10. The first base member 12 may include at least one of polyethylene, polypropylene, polyethylene terephthalate, polyethylene-2,6-naphthalate, polypropylene terephthalate, polyimide, polyamide-imide, polyether sulfone, polyether ether ketone, polycarbonate, polyacrylate, cellulose propionate, polyvinyl chloride, polyvinylidene chloride, polyvinyl alcohol, polyether imide, polyphenylene sulfide, polyphenylene oxide and polystyrene. For example, the first base member 12 may be formed of polyethylene terephthalate. However, the present invention is not limited thereto and, in addition to the above-described materials, various other materials may be used as the first base member 12.

The first sensor electrode 142 formed on the first base member 12 may include first sensor parts 142a located in the active area AA, first connection parts 142b to connect neighboring first sensor parts 142a, and the first wiring electrode 144 extending from the first sensor parts 142a or the first connection parts 142b in the active area AA and located in the non-active areas NA.

The first sensor parts 142a are parts which actually sense whether or not an input unit, such as a finger, contacts the first sensor electrodes 142. The drawings exemplarily illustrate the first sensor parts 142a as having a diamond shape so as to be formed in a large area in the active area AA together with the second sensor parts 242a of the second sensor electrodes 242 and thus to effectively sense touch. However, the present invention is not limited thereto, and the first sensor parts 142a may have various shapes, i.e., a polygonal shape, such as a triangular shape or a rectangular shape, a circular shape, an oval shape, etc. The first connection parts 142b connect the first sensor parts 142a in a first direction (in the horizontal direction in the drawings). Therefore, the first sensor electrodes 142 may extend in the first direction in the active area AA.

In this embodiment, the first sensor electrodes 142 may include a transparent conductive material which is conductive and light transmissive. For example, the first sensor electrode 142 may include conductors 14a formed of a nanomaterial having a network structure (for example, metal nanowires, such as silver nanowires, copper nanowires or platinum nanowires). Here, the network structure means a net or mesh structure in which neighboring conductors formed of a nanomaterial, such as wires, are tangled to form contact points and are thus conductively connected through the contact points.

If the first sensor electrodes 142 include the conductors 14a formed of a transparent conductive nanomaterial, the first sensor electrodes 142 may be formed through a wet coating method which has inexpensive process costs, as compared to a deposition method. That is, the first sensor electrodes 142 may be formed by forming an electrode layer through a wet coating method in which a paste, an ink, a mixture or a solution including conductors formed of a nanomaterial, such as nanowires, is applied and then patterning the electrode layer. Here, in the solution, the mixture or the paste used in wet coating, a concentration of the conductors 14a formed of a nanomaterial is very low (for example, 1% or less). Therefore, costs necessary to form the first sensor electrodes 142 may be reduced and thus productivity may be improved.

Further, if the first sensor electrodes 142 include the conductors 14a formed of a nanomaterial, the first sensor electrodes 142 may be light transmissive and have low resistance and excellent electrical characteristics. For example, silver (Ag) nanoparticles have various crystal surfaces and may thus easily cause anisotropic growth, thereby easily manufacturing silver nanowires. The silver nanowires have resistance of about 10 Ω/□ to 400 Ω/□, and, thus, low resistance (for example, of 10 Ω/□ to 150 Ω/□) may be achieved. Therefore, the first sensor electrodes 142 having various resistances may be formed. Particularly, the first sensor electrodes 142 having higher electrical conductivity than indium tin oxide having resistance of about 200 Ω/□ to 400 Ω/□ may be formed. Further, the silver nanowires have higher transmittance than indium tin oxide and, for example, may have transmittance of 90% or more. Further, the silver nanowires are flexible and may thus be applied to a flexible device, and are stable in material supply and demand.

For example, the above-described nanowires (particularly, silver nanowires) may have a radius of 10 nm to 60 nm and a major axis length of 10 μm to 200 μm. The nanowires have an excellent aspect ratio (for example, 1:300-1:20000) within such ranges and may thus easily form a network structure and allow the first sensor electrodes 142 not to be easily visible. However, the present invention is not limited thereto and, the aspect ratio, major axis length and aspect ratio of the nanowires may have various values.

In this embodiment, the first sensor electrodes 142 include the conductors 14a formed of a nanomaterial having a network structure and, thus, material costs may be reduced and various characteristics may be improved.

In the first sensor electrodes 142 formed as a conductive layer including the conductors 14a formed of a nanomaterial forming a network structure, the conductors 14a formed of the nanomaterial may be located within the layer having a uniform thickness or vacant spaces may be formed between the conductors 14a formed of the nanomaterial. Actually, the first sensor electrodes 142 are formed by applying a mixture of the conductors 14a formed of the nanomaterial and a small amount of a solvent or a binder. Therefore, in the first sensor electrode 142, a residual part 14b formed by the remainder of the solvent or the binder has a first thickness T1 which is relatively small, and the conductors 14a extend to the outside of the residual part 14b. Thereby, the network structure formed by the conductors 14a may have a second thickness T2 which is relatively great. Hereinafter, the thickness of the first sensor electrode 142 does not mean the first thickness T1, i.e., the thickness of the residual part 14b, but means the second thickness T2, i.e., the overall thickness of a layer in which the residual part 14b and the conductors 14a protruding upward from the residual part 14b are located.

The thickness of the first sensor electrodes 142 may be variously varied according to the size of the touch panel 10, a required resistance value, and the material of the first sensor electrodes 142. Here, if the first sensor electrodes 142 include metal nanowires having a network structure, the thickness of the first sensor electrodes 142 may be minimized, for example, be 50 nm to 350 nm. The reason for this is that the first sensor electrodes 142 having such a thickness may be easily formed so as to have a desired resistance. However, the present invention is not limited thereto, and the thickness of the first sensor electrodes 142 may have various values.

The first overcoating layer 16 covering the first sensor electrodes 142 on the first base ember 12 serves to physically and chemically protect the first sensor electrodes 142. Concretely, the first overcoating layer 16 covers and surrounds the outer surfaces of the conductors 14a extending to the outside of the residual part 14b and may thus prevent the conductors 14a from being damaged or oxidized. In more detail, the first overcoating layer 16 may prevent the conductors 14a exposed upward from the residual part 14b from being physically damaged, i.e., being bent by external force. Further, since the conductors 14a may be oxidized and thus electrical conductivity of the conductors 14a may be lowered if the conductors 14a are exposed to the atmosphere for a long time, the first overcoating layer 16 may be formed to cover the conductors 14a so as to prevent such a problem. In this embodiment, since the first sensor electrodes 142 include the conductors 14a formed of a nanomaterial forming a network structure, the first overcoating layer 16 is formed so as to improve physical stability of the conductors 14a and to prevent the conductors 14a from being oxidized. For example, some parts of the first overcoating layer 16 may be impregnated into spaces between the conductors 14a and fill the spaces between the conductors 14a, and other parts of the first overcoating layer 16 may be formed on the conductors 14a. Differently from this embodiment, even if the conductors 14a do not protrude upward from the residual part 14b and are located within the residual part 14b, the first overcoating layer 16 may prevent the conductors 14a from being oxidized by the atmosphere invading the inside of the residual part 14a. For this purpose, the first overcoating layer 16 may be formed so as to directly contact the first sensor electrodes 142 or the conductors 14a.

The first overcoating layer 16 covering the first sensor electrodes 142 on the first base member 12 may be formed all over. Here, overall formation of the first overcoating layer 16 may not only include a case that the first overcoating layer 16 is completely formed throughout all regions without any gap but also include a case that the first overcoating layer 16 is not inevitably formed in some regions.

The first overcoating layer 16 may be formed of a resin. For example, the first overcoating layer 16 may be formed of acrylic resin, but the present invention is not limited thereto and the first overcoating layer 16 may include other materials. The first overcoating layer 16 may be formed all over to cover the first sensor electrodes 142 through various coating methods.

For example, the thickness of the first overcoating layer 16 may be 5 nm to 50 nm. If the thickness of the first overcoating layer 16 is less than 5 nm, effects of the first overcoating layer 16 of preventing the conductors 14 from being oxidized may not be sufficient. Further, if the thickness of the first overcoating layer 16 exceeds 50 nm, material costs may be increased. However, the present invention is not limited thereto and the thickness of the first overcoating layer 16 may have various values.

The drawings and the above-described embodiment exemplarily illustrate and describe the residual parts 14b of the first sensor electrodes 142 and the first overcoating layer 16 as being formed as different layers. However, the present invention is not limited thereto. In accordance with another embodiment, by applying an ink in which materials forming the conductors 14a and the residual parts 14b of the first sensor electrodes 142 and the first overcoating layer 16 are mixed, the conductors 14a may be located within a single layer, i.e., the first overcoating layer 16. Of course, various other modifications are possible.

In the non-active areas NA, the first wiring electrodes 144 are located. The first wiring electrodes 144 may extend so as to be connected to the first flexible printed circuit board 19.

In this embodiment, the first wiring electrodes 144 may be located on the first overcoating layer 16. Here, the first wiring electrodes 144 and the first sensor electrodes 142 may be conductively connected to each other by stacking the first wiring electrodes 144 and the first sensor electrodes 142 with the first overcoating layer interposed therebetween. Otherwise, the first wiring electrodes 144 and the first sensor electrodes 142 may contact each other and thus be conductively connected to each other by removing the entirety or a part of the first overcoating layer 16 located between the first wiring electrodes 144 and the first sensor electrodes 142. However, the present invention is not limited thereto and the first wiring electrodes 144 may be located so as to be coplanar with the first sensor electrodes 142 and thus directly contact the first sensor electrodes 142. In addition, various other modifications are possible.

The first wiring electrodes 144 may be formed of a metal material having excellent conductivity. In this case, even if the first wiring electrodes 144 have a small width, the first wiring electrodes 144 have low resistance and may thus have sufficient electrical characteristics. The first wiring electrodes 144 may be formed through various methods. For example, the first wiring electrodes 144 may be formed by applying a conductive paste through various coating method and then hardening the conductive paste through heat treatment or plastic hardening the conductive paste. The first wiring electrodes 144 may be formed of a metal material so as to have excellent electrical conductivity. For example, the first wiring electrodes 144 may be formed of a conductive paste including conductive powder, such as silver (Ag).

However, the present invention is not limited thereto and the first wiring electrodes 144 may have various shapes and include various conductive materials. For example, although this embodiment exemplarily illustrates the first sensor electrodes 142 and the first wiring electrodes 144 as being formed of different materials, the first sensor electrodes 142 and the first wiring electrodes 144 may be formed of the same material and thus have an integral structure. In this case, the first wiring electrodes 144 may include the conductors 14a formed of the same nanomaterial as the first sensor electrodes 142. Thus, a manufacturing process of the first sensor electrodes 142 and the first wiring electrodes 144 may be simplified. In this case, the first wiring electrodes 144 are not located on the first overcoating layer 16. That is, the first sensor electrodes 142 and the first wiring electrodes 144 may be formed to be coplanar with each other on the first base member 12, and the first overcoating layer 16 may be formed to cover both the first sensor electrodes 142 and the first wiring electrodes 144.

Further, the drawings exemplarily illustrate the first wiring electrodes 144 as being connected to the outside through two non-active areas NA located at both sides of the active area AA. However, the present invention is not limited thereto, and the first wiring electrodes 144 may be connected to the outside through one non-active area NA located at one side of the active area AA or may extend to one of an upper side part and a lower side part of the active AA and then be connected to the outside through such a part. In addition, various other modifications are possible.

The first wiring electrodes 144 may be connected to the first flexible printed circuit board 19 for connection to the outside. The first flexible printed circuit board 19 may include a base member and a wiring part formed on the base member. The first wiring electrodes 144 and the first flexible printed circuit board 19 may be conductively connected by contact between the wiring part of the first flexible printed circuit board 19 and the first wiring electrodes 144. However, the present invention is not limited thereto, and the first wiring electrodes 144 and the first flexible printed circuit board 19 may be conductively connected by locating a conductive adhesive member (not shown), such as an anisotropic conductive adhesive (ACA), an anisotropic conductive paste (ACP) or an anisotropic conductive film (ACF).

The drawings exemplarily illustrate a double routing structure in which the first wiring electrodes 144 are located at both ends of the first sensor electrodes 142. Since the first sensor electrodes 142 extend to a relatively long length, such a structure may lower resistance of the first sensor electrodes 142 and prevent loss due to resistance. However, the present invention is not limited thereto and various structures, including a single routing structure in which the first wiring electrodes 144 are formed at only one side of the first sensor electrodes 142, may be formed.

Further, the drawings exemplarily illustrate the first wiring electrodes 144 as being connected to the outside through two non-active areas NA located at both sides of the active area AA. However, the present invention is not limited thereto, and the first wiring electrodes 144 may be connected to the outside through one non-active area NA located at one side of the active area AA or may extend to one of an upper side part and a lower side part of the active AA and then be connected to the outside through such a part. In addition, various other modifications are possible.

The first hard coating layer 18 may be located on the other surface of the first conductive film 10 opposite to the surface of the first conductive film 10 provided with the first electrodes 42 and the first overcoating layer 16 formed thereon.

In this embodiment, the first hard coating layer 18 located on the other surface of the first conductive film is located as a top surface of the touch panel 100, thus constituting an outer surface OS of the touch panel 100. Therefore, in this embodiment, the first hard coating layer 18 may have a sufficient hardness so as to prevent the touch panel 100 from being damaged by external impact. For example, the hardness of the first hard coating layer 18 (for example, the hardness of a pencil) may be 3H or more (for example, 3H to 7H). The first hard coating layer 18 having such a hardness may be formed of high hardness polyethylene terephthalate (PET) or high hardness polymethylmethacrylate (PMMA) and further include fluorine additives, silica particles, various additives, etc. The first hard coating layer 18 may be formed by wet-coating a thermosetting or UV curable composite and then hardening the composite. However, the present invention is not limited thereto and the material, manufacturing process, etc. of the first hard coating layer 18 may be variously modified.

For example, the hardness of the first hard coating layer 18 may be greater than the hardness of a second hard coating layer 28 and thus effectively prevent damage due to external impact. Otherwise, the first hard coating layer 18 and the second hard coating layer 28 may be formed of materials having the same components and thus have the same hardness or almost similar hardnesses. In this case, the first conductive film 10 and the second conductive film 20 may be formed of the same material and a manufacturing process thereof may be simple.

Further, the thickness of the first hard coating layer 18 may be 1 μm to 10 μm. For example, the thickness of the first hard coating layer 18 may be 1 μm to 5 μm. Here, the thickness of the first hard coating layer 18 may be less than the thickness of the first base member 12 and be greater than the thickness of the first overcoating layer 16 and the thickness of the first electrodes 42. The reason for this is that the first hard coating layer 18 having such a thickness may minimize the thickness of the touch panel 100 and sufficiently prevent the touch panel 10 from being damaged by external impact, etc.

The second conductive film 20 may include a second base member 22, the first electrodes 24 formed on one surface of the second base member 22, a second overcoating layer 26 covering the second electrodes 24 at least in the active area AA, and the second hard coating layer 28 located on the other surface of the second base member 22 opposite to the second electrodes 24 and the second overcoating layer 26. Here, the second electrodes 24 may include the second sensor electrodes 242 located in the active area AA, and the second wiring electrodes 244 conductively connected to the second sensor electrodes 142 in the non-active area NA.

The above description of the first base member 12 may be applied to the second base member 22 and a detailed description of the second base member 22 will thus be omitted.

The second sensor electrode 242 formed on the second base member 22 may include second sensor parts 242a located in the active area AA, second connection parts 242b to connect neighboring second sensor parts 242a, and the second wiring electrode 244 extending from the second sensor parts 242a or the second connection parts 242b in the active area AA and located in the non-active area NA.

The second connection parts 242b connect the second sensor parts 242a in a second direction (in the vertical direction in the drawings) and, thus, the second sensor electrodes 242 may extend in the second direction in the active area AA. Except for the extending direction of the second sensor electrodes 242, the above description of the first sensor electrodes 142 may be applied to the second sensor electrodes 242.

In the non-active area NA, the second wiring electrodes 244 are located on the second overcoating layer 26. The second wiring electrodes 244 may extend so as to be connected to the second flexible printed circuit board 29.

The drawings exemplarily illustrate a single routing structure of the second wiring electrodes 244. Therefore, the second wiring electrodes 244 are formed in the non-active area NA located at the lower side part of the active area AA. However, the present invention is not limited thereto, and the second wiring electrodes 244 may be located at at least one of the upper side part, the lower side part, the left side part and the right side part of the active area AA and various other modifications of the second wiring electrodes 244 are possible.

The above description of the first wiring electrodes 144 and the first flexible printed circuit board 19 may be applied to the second wiring electrodes 244 and the second flexible printed circuit board 29 and a detailed description thereof will thus be omitted.

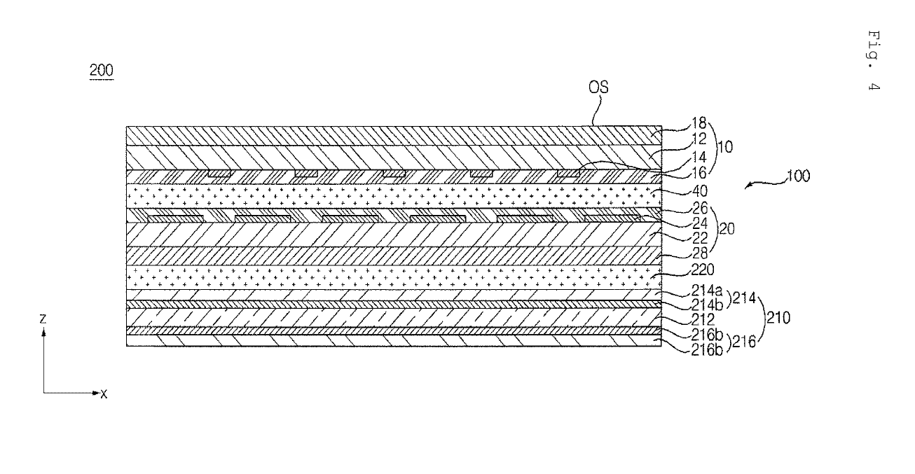

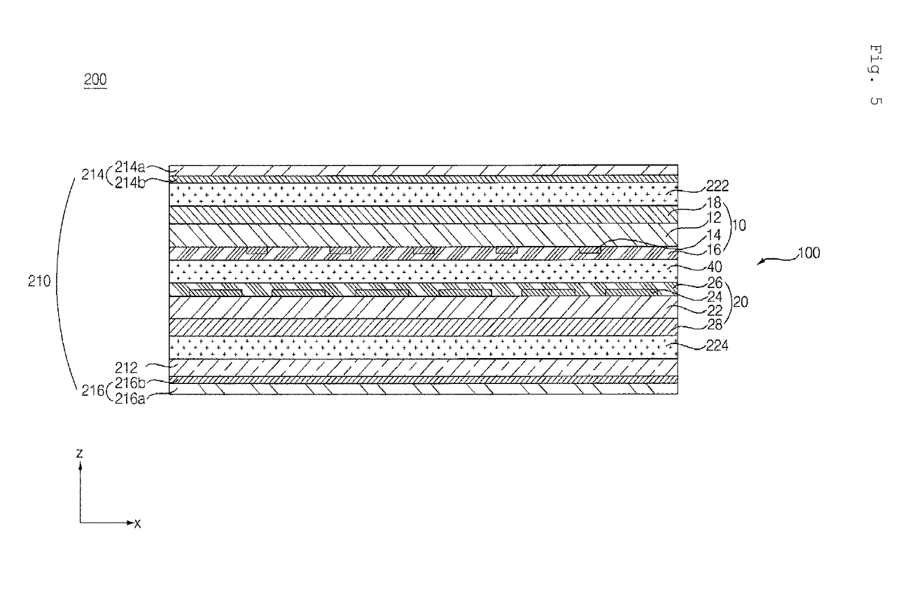

The second hard coating layer 28 is located on the other surface (the lower surface in the drawing) of the second conductive film 20 which is opposite to the surface (the upper surface in the drawing) of the second conductive film 20 provided with the second electrodes 24 and the second overcoating layer 26 formed thereon. With reference to FIGS. 4 and 5, since at least a part of a display panel 210 is located on the surface of the second conductive film 20 provided with the second hard coating layer 28 formed thereon, external impact is not applied directly to the second hard coating layer 28 and, thus, the second hard coating layer 28 may have lower hardness than that of the first hard coating layer 18, as described above. Otherwise, in consideration of the manufacturing process, the second hard coating layer 28 may have equal hardness or almost similar hardness to that the first hard coating layer 18. Except for hardness, the above description of the first hard coating layer 18 may be applied to the second hard coating layer 28.

The transparent adhesive layer 40 to adhere the first conductive film 10 and the second conductive film 20 to each other is located between the first conductive film 10 and the second conductive film 20. The transparent adhesive layer 40 may be formed of a material, which is light transmissive and has adhesiveness to adhere both layers located on both surfaces thereof to each other, i.e., an optically clear adhesive (OCA). The optically clear adhesive prevents degradation of the first and/or second electrodes 14 and 24 and has excellent adhesiveness, moisture resistance, heat resistance, foaming property and processability. Various materials known as the optically clear adhesive may be used as the transparent adhesive layer 40.

As described above, in this embodiment, the first sensor electrodes 142 are located on one surface (the lower surface in the drawings) of the first conductive film 10 which faces the transparent adhesive layer 40, and the second sensor electrodes 242 are located on one surface (the upper surface in the drawings) of the second conductive film 20 which faces the transparent adhesive layer 40. For example, the first sensor electrodes 142 and the second sensor electrodes 144 may be opposite each other with the transparent adhesive layer 40 interposed therebetween.

Therefore, the first sensor electrodes 142 are located on the surface of the first conductive film 10 within the touch panel 100, and the other surface of the first conductive film 10 not provided with the first sensor electrodes 142 is positioned as a top surface of the touch panel 100 and may thus constitute the outer surface OS of the touch panel 100. Therefore, the first sensor electrodes 142 may be safely protected without a separate glass cover.

Further, the second sensor electrodes 242 are located on the surface of the second conductive film 20 within the touch panel 100, and at least a part of the display panel 210 may be located on the other surface of the second conductive film 20 not provided with the second sensor electrodes 242. Therefore, the second sensor electrodes 242 may be more safely protected during a bonding process of the touch panel 100 and the display panel 210. In addition, a distance between the first sensor electrodes 142 and the second sensor electrodes 242 may be reduced and touch sensitivity may be improved.

As described above, in this embodiment, the distance between the first sensor electrodes 142 and the second sensor electrodes 242 is short and, thus, the transparent adhesive layer 40 may have low permittivity. Therefore, even if the distance between the first sensor electrodes 142 and the second sensor electrodes 242 is short, misrecognition of touch may be effectively prevented.

For example, the permittivity of the transparent adhesive layer 40 may be 4 F/m or less (in more detail, 1 to 4 F/m). If the permittivity of the transparent adhesive layer 40 exceeds 4 F/m, misrecognition of touch may occur due to a short distance between the first sensor electrodes 142 and the second sensor electrodes 242. Further, since the permittivity of a vacuum is 1 F/m, the transparent adhesive layer 40 in accordance with this embodiment may have permittivity of 1 F/m or more. In more detail, the permittivity of the transparent adhesive layer 40 may be 2.5 to 3.5 F/m. Within such a range, misrecognition of touch may be effectively prevented.

The transparent adhesive layer 40 may be formed by applying a composite including an initiator, a monomer, additives, a solvent, etc. and then hardening the composite. Here, since the permittivity of the transparent adhesive layer 40 is adjusted by the content of the monomer, the transparent adhesive layer 40 having a desired permittivity may be formed by adjusting the content of the monomer.

In this embodiment, the thickness of the transparent adhesive layer 40 may be 30 μm to 150 μm. Within such a range, the transparent adhesive layer 40 may have excellent adhesive effects. The transparent adhesive layer 40 may effectively insulate the first sensor electrodes 142 and the second sensor electrodes 242 from each other and prevent misrecognition of touch. However, the present invention is not limited thereto and the thickness of the transparent adhesive layer 40 may have various values.

In this embodiment, the touch panel 100 may be manufactured by bonding the first conductive film 10 and the second conductive film 20 using the transparent adhesive layer 40. That is, since a separate cover glass substrate is not used, the thickness and weight of the touch panel 100 may be decreased and manufacturing costs of the touch panel 100 may be reduced. Particularly, the touch panel 100 is applied to a display device, which does not require high reliability and durability, and may thus reduce manufacturing costs and improve portability.

In order to clearly and briefly describe the present illustrate and state that the first conductive film 10 includes the first base member 12, the first electrodes 14, the first overcoating layer 16 and the first hard coating layer 18, and the second conductive film 20 includes the second base member 22, the second electrodes 24, the second overcoating layer 26 and the second hard coating layer 28. However, the present invention is not limited thereto. Therefore, the first and second conductive films 10 and 20 may further include adhesive layers, primer layers, etc. to improve adhesive characteristics between stacked layers. In addition, various structures may be applied as the structures of the first and second conductive films 10 and 20.

Hereinafter, a touch panel and a display device including the same in accordance with another embodiment of the present invention will be described in detail. A detailed description of some parts in this embodiment, which are substantially the same as or similar to those in the former embodiment, will be omitted because it is considered to be unnecessary. The above-described embodiments, modified embodiments which may be applied thereto, embodiments which will be described below, and modified embodiments which may be applied thereto may be variously combined.

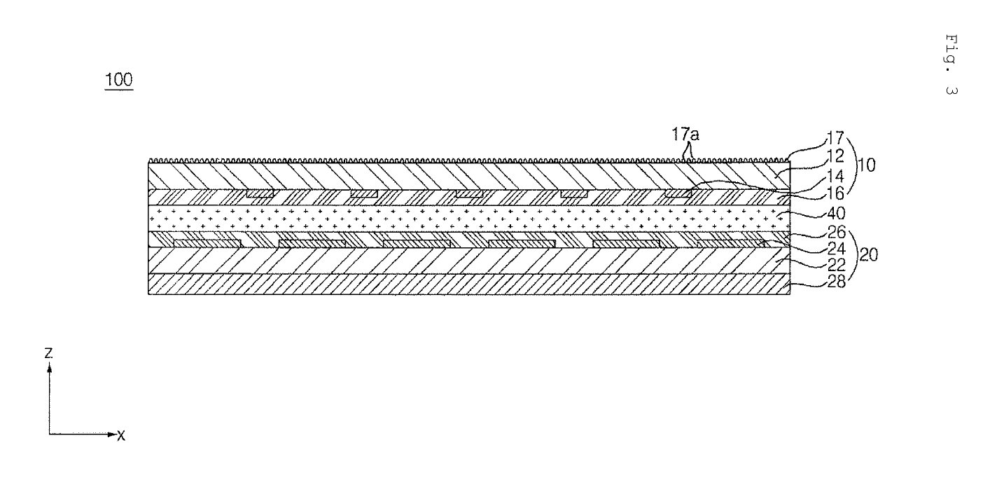

FIG. 3 is a cross-sectional view illustrating a touch panel in accordance with another embodiment of the present invention.

With reference to FIG. 3, a moth-eye structure 17 is formed on the other surface of a first conductive film 10 in accordance with this embodiment which is opposite to one surface of the first conductive film 10 provided with first electrodes 14 and a first overcoating layer 16 formed thereon.

Here, the moth-eye structure 17 is devised considering that eyes of nocturnal insets, such as moths, do not reflect light regardless of the incidence angle of light and the wavelength of light. That is, based on the principle that eyes of a moth formed by aligning inclined protrusions having a nanoscale do not reflect light, formation of inclined protrusions prevents light reflection.

The moth-eye structure 17 includes a plurality of protrusions 17a which have a nanoscale (for example, 1 nm to 999 nm) and have an area gradually decreased in the outward direction. In a nanoscale pattern, even if the pattern is formed of the same material and thus has a uniform refractive index, it is recognized that the refractive index is gradually decreased as the size of the pattern is decreased. Therefore, it is recognized that the refractive index of the moth-eye structure 17 is gradually decreased in the outward direction, i.e., the moth-eye structure 17 has a gradient refractive index, and thus the moth-eye structure 17 does not cause Fresnel reflection.

In this embodiment, the moth-eye structure 17 may directly contact the other surface (the upper surface in the drawing) of the first base member 12 of the first conductive film 10. For example, the first conductive film 10 may be manufactured by forming the first electrodes 14 and the first overcoating layer 16 on the other surface of the first base member 12 provided with the moth-eye structure 17 formed on one surface thereof. In this embodiment, the moth-eye structure 17 is formed directly on the first base member 12 without an adhesive layer and, thus, the overall thickness may be reduced by a thickness corresponding to the adhesive layer.

The moth-eye structure 17 is not formed on one surface (the surface provided with the first electrodes 14, i.e., the lower surface in the drawing) of the first base member 12 of the first conductive film 10 and/or a second conductive film 20. The reason for this is that these positions cause a difficulty in expecting reflection preventive effects of the moth-eye structure 17.

In this embodiment, since a separate cover glass substrate is not provided on the front surface of the touch panel 100, the manufacturing costs of the touch panel 100 may be reduced and the thickness and weight of the touch panel 100 may be decreased. However, if a cover glass substrate is not provided, when a display device 200 (with reference to FIGS. 4 and 5) including the touch panel 100 is installed outdoors or is strongly influenced by ambient light, the display device 200 may reflect external light and thus display characteristics of the display device 200 may be lowered. In this embodiment, since the moth-eye structure 17 is provided on the outer surface of the touch panel 100, the display panel 100 may effectively prevent reflection of external light without a separate cover glass substrate and thus improve display characteristics.

This embodiment exemplarily describes the single moth-eye structure 17 as being formed on the other surface of the first base member 12. However, the present invention is not limited thereto, and a first hard coating layer 18 shown in FIG. 2 may be located on the other surface of the first base member 12 and the moth-eye structure 17 may be located on the first hard coating layer 18. Otherwise, a protective layer covering the entirety of the moth-eye structure 17 may be located on the moth-eye structure 17. Such a protective layer may prevent the moth-eye structure 17 from collapsing or being damaged. In this case, the protective layer covering the moth-eye structure constitutes the outer surface of the touch panel 100. Various known materials may be used as the protective layer. However, the protective layer is not essential and may thus be omitted.

FIG. 4 is a cross-sectional view illustrating a display device in accordance with one embodiment of the present invention.

With reference to FIG. 4, a display device 200 in accordance with this embodiment may include a display panel 210 and a touch panel 100 integrated with the display panel 210. The display panel 210 may include a display panel 212 on which an image is substantially displayed, a front substrate 214 located on a front surface of the display panel 212, and a rear substrate 216 located on a rear surface of the display panel 212. The display panel 210 may further include a backlight unit to provide light to the display panel 212, a driving unit to drive the display panel 212, etc.

The display panel 212 may be one of panels having various structures, which may display an image, and, for example, be a liquid crystal display (LCD). The display panel 212 may have various structures and be operated through various methods and, thus, the present invention is not limited thereto.

The front substrate 214 may include a transparent substrate 214a, and a polarizing plate 214b adhered to the transparent substrate 214a (in more detail, adhered to the inner upper surface of the transparent substrate 214a). The polarizing plate 214b serves to polarize light to display a desired image. The polarizing plate 214b may have various structures which may polarize light and be operated through various methods. However, the present invention is not limited thereto and various films in addition to the polarizing plate 214b may be located on the front substrate 214.

The rear substrate 216 may include a transparent substrate 216a, and a polarizing plate 216b adhered to the transparent substrate 216a (in more detail, adhered to the inner upper surface of the transparent substrate 216a). The polarizing plate 216b serves to polarize light to display a desired image. The polarizing plate 216b may have various structures which may polarize light and be operated through various methods. However, the present invention is not limited thereto and various films in addition to the polarizing plate 216b may be located on the rear substrate 216.

In this embodiment, the touch panel 100 is generally located on the front surface of the display panel 210, and an adhesive layer 220 to adhere the touch panel 100 and the display panel 210 to each other is located between the touch panel 100 and the display panel 210. Therefore, first and second conductive films 10 and 20 and a transparent adhesive layer 40 of the touch panel 100 are located on the front substrate 214 of the display panel 210 and, thus, the touch panel 100 may be integrated with the display panel 210 in an on-cell structure. Here, both surfaces of the adhesive layer 220 may contact the rear surface of the touch panel 100 and the front surface of the display panel 210.

The permittivity of the adhesive layer 220 may be greater than the permittivity of the transparent adhesive layer 40 located between the first conductive film 10 and the second conductive film 20. The reason for this is that the permittivity of the transparent adhesive layer 40 located between the first conductive film 10 and the second conductive film 20 has a relatively small value so as to prevent misrecognition of touch. However, the present invention is not limited thereto and the permittivity of the adhesive layer 220 may be equal to or less than the permittivity of the transparent adhesive layer 40.

That is, the adhesive layer 220 is located between the second conductive film 20 of the touch panel 100 and the display panel 210 and thus integrates the touch panel 100 and the display panel 210, and the first hard coating layer 18 located on the other surface (the upper surface in the drawing) of the first conductive film 10 of the touch panel 100 constitutes an outer surface OS of the touch panel 100 or the display device 200.

Although the drawing exemplarily illustrates the first hard coating layer 18 as being located on the other surface of the first conductive film 10, the present invention is not limited thereto. As exemplarily shown in FIG. 3, a moth-eye structure 17 may be located on the other surface of the first conductive film 10 and, in accordance with a modified embodiment, both a first hard coating layer 18 and a moth-eye structure 17 may be located on the other surface of the first conductive film 10.

FIG. 5 is a cross-sectional view illustrating a display device in accordance with another embodiment of the present invention.

With reference to FIG. 5, a display device 200 in accordance with this embodiment may include a display panel 210 and a touch panel 100 integrated with the display panel 210. Here, the above description of the display panel 210 of FIG. 4 may be applied to the display panel 210 and a detailed description thereof will thus be omitted.

In this embodiment, a front substrate 214 may be located on the front surface of the touch panel 100, and a display panel 212 and a rear substrate 216 may be located on the rear surface of the touch panel 100. Here, a first adhesive layer 222 to adhere the touch panel 100 and the front substrate 214 to each other may be located between the touch panel 100 and the front substrate 214, and a second adhesive layer 224 to adhere the touch panel 100 and the display panel 212 to each other may be located between the touch panel 100 and the display panel 212. The touch panel 100 may be located within the display panel 210 and be integrated with the display panel 210 in an in-cell structure. Therefore, the other surface of the first conductive film 10 of the touch panel 100 may be located at the side of the outer surface of the display device 200.

The permittivity of at least one of the first and second adhesive layers 222 and 224 may be greater than the transparent adhesive layer 40 located between the first conductive film 10 and the second conductive film 20. The reason for this is that the permittivity of the transparent adhesive layer 40 located between the first conductive film 10 and the second conductive film 20 has a relatively small value so as to prevent misrecognition of touch. However, the present invention is not limited thereto and the permittivities of the first and second adhesive layers 222 and 224 may be equal to or less than the permittivity of the transparent adhesive layer 40.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A touch panel comprising:
a first conductive film including first sensor electrodes on one surface thereof;
a second conductive film including second sensor electrodes insulated from the first sensor electrodes; and
a transparent adhesive layer positioned between the first conductive film and the second conductive film, wherein:
the first sensor electrodes are positioned on one surface of the first conductive film facing the transparent adhesive layer, and the second sensor electrodes are positioned on one surface of the second conductive film facing the transparent adhesive layer; and
the other surface of the first conductive film opposite to the one surface thereof is positioned on a top surface of the touch panel to constitute an outer surface of the touch panel.

2. The touch panel according to claim 1, wherein a permittivity of the transparent adhesive layer is 4 F/m or less.

3. The touch panel according to claim 2, wherein the permittivity of the transparent adhesive layer is 1 to 4 F/m or less.

4. The touch panel according to claim 1, wherein a thickness of the transparent adhesive layer is 30 μm to 150 μm.

5. The touch panel according to claim 1, wherein the first conductive film further includes:
a first base member provided with the first sensor electrodes formed on one surface thereof; and
a first hard coating layer located on the other surface of the first base member,
wherein the first hard coating layer forms the top surface of the touch panel to constitute the outer surface of the touch panel.

6. The touch panel according to claim 5, wherein a hardness of the first hard coating layer is 3H or more.

7. The touch panel according to claim 6, wherein the hardness of the first hard coating layer is 3H to 7H.

8. The touch panel according to claim 5, wherein the first hard coating layer includes polyethylene terephthalate (PET) or polymethylmethacrylate (PMMA).

9. The touch panel according to claim 5, wherein a thickness of the first hard coating layer is 1 μm to 10 μm.

10. The touch panel according to claim 5, wherein a thickness of the first hard coating layer is less than a thickness of the first base member and is greater than a thickness of the first sensor electrodes.

11. The touch panel according to claim 5, wherein:
the first sensor electrodes include conductors formed of a nanomaterial forming a network structure; and
the first conductive film further includes a first overcoating layer to cover the first sensor electrodes,
wherein a thickness of the first hard coating layer is greater than a thickness of the first overcoating layer.

12. The touch panel according to claim 1, wherein the first conductive film further includes:
a first base member provided with the first sensor electrodes formed on one surface thereof; and
a moth-eye structure located on the other surface of the first base member,
wherein the moth-eye structure is positioned on the top surface of the touch panel to constitute the outer surface of the touch panel.

13. The touch panel according to claim 1, wherein the second conductive film further includes:
a second base member provided with the second sensor electrodes formed on one surface thereof; and
a second overcoating layer to cover the second sensor electrodes; and
a second hard coating layer located on the other surface of the second base member,
wherein the first sensor electrodes include conductors formed of a nanomaterial forming a network structure.

14. The touch panel according to claim 13, wherein a hardness of the first hard coating layer is equal to or greater than a hardness of the second hard coating layer.

15. A display device comprising:
a display panel; and
a touch panel integrated with the display panel, wherein the touch panel includes:
a first conductive film including first sensor electrodes on one surface thereof;
a second conductive film including second sensor electrodes insulated from the first sensor electrodes; and
a transparent adhesive layer positioned between the first conductive film and the second conductive film, wherein:
the first sensor electrodes are positioned on one surface of the first conductive film facing the transparent adhesive layer, and the second sensor electrodes are positioned on one surface of the second conductive film facing the transparent adhesive layer; and
the other surface of the first conductive film opposite to the one surface thereof is positioned on a top surface of the touch panel.

16. The display device according to claim 15, wherein the display panel includes:
a display panel;
a front substrate located on a front surface of the display panel; and
a rear substrate located on a rear surface of the display panel,
wherein the touch panel is located on a front surface of the front substrate.

17. The display device according to claim 16, further comprising an adhesive layer located between the touch panel and the front substrate so as to adhere the touch panel and the front substrate to each other,
wherein:
the other surface of the first conductive film constitutes an outer surface of the display device; and
a permittivity of the transparent adhesive layer is less than a permittivity of the adhesive layer.

18. The display device according to claim 15, wherein the display panel includes:
a display panel;
a front substrate located on a front surface of the display panel; and
a rear substrate located on a rear surface of the display panel,
wherein the touch panel is located between the front substrate and the display panel.

19. The display device according to claim 18, further comprising a first adhesive layer located between the touch panel and the front substrate so as to adhere the touch panel and the front substrate to each other, and a second adhesive layer located between the touch panel and the display panel so as to adhere the touch panel and the display panel to each other,
wherein a permittivity of the transparent adhesive layer is less than a permittivity of at least one of the first and second adhesive layers.
